(19) United States
(12) Patent Application Publication
(10) Pub. No.: US 2019/0195559 A1
(43) Pub. Date: Jun. 27, 2019

(54) Grain Bin Dryer Pressure Control System

(71) Applicant: Superior Manufacturing LLC, Kindred, ND (US)

(72) Inventor: Claire M. Rauser, Kindred, ND (US)

(73) Assignee: Superior Manufacturing LLC

(21) Appl. No.: 15/851,235

(22) Filed: Dec. 21, 2017

(51) Int. Cl. F26B 21/10; A23B 9/08

(52) U.S. Cl. CPC F26B 21/10; F26B 2200/06; A23B 9/08

(57) ABSTRACT

A grain bin dryer pressure control system for reducing the risk of excess pressure inside a grain bin while grain is being dried. The grain bin dryer pressure control system generally includes a static pressure sensor mounted inside a grain bin and a controller. The controller comprises an input coupled to receive a signal from the pressure sensor indicative of a static pressure inside the grain bin and a first output operable to shut off power to the drying fan when the static pressure inside the grain bin exceeds a predetermined value.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND

### Field

Example embodiments in general relate to a grain bin dryer pressure control system for reducing the risk of excessive pressure within a grain bin.

### Related Art

Any discussion of the related art throughout the specification should in no way be considered as an admission that such related art is widely known or forms part of common general knowledge in the field.

After grain is harvested, it is stored in a grain bin prior to sale. FIG. 1 illustrates a typical prior art cylindrical grain bin 10 filled with grain 12. The bin 10 includes sidewalls 14 with a door 16 for access to the interior, a roof 18 with one or more exhaust vents 20, a bottom 22, and a floor 24 with slots 26. The space between the bottom 22 and the floor 24 defines a plenum 28.

In order to remove moisture from the grain and prevent it from molding, one or more dryer fans 30 are used to force air through the plenum 28 and the slots 26. The air circulates through the grain 12 and exits the bin 10 through the vents 20, as indicated by the arrows, carrying with it moisture removed from the grain. Heaters (not shown) may be used in conjunction with the fans 30 to speed the drying.

In certain situations, the exhaust vents 20 in the roof 18 may become partially or completely obstructed. For example, in very cold weather the moisture removed from the grain 12 may condense in or around the exhaust vents 20 and freeze. Grain dust, fines, or other debris may also block the vents 20. With the exhaust route obstructed, pressure may build up in the bin 10 when the drying fans 30 are running. Given enough time, the pressure may increase to such an extent that the roof 10 bulges outward (see FIG. 2) and, in extreme circumstances, separate from the bin 10 causing extensive damage that is costly and time consuming to repair.

### SUMMARY

An example embodiment of the present invention is directed to a grain bin dryer pressure control system. The grain bin dryer pressure control system generally includes a static pressure sensor mounted inside a grain bin and a controller. The controller includes an input coupled to receive a signal from the pressure sensor indicative of a static pressure inside the grain bin. The controller also includes a first output operable to shut off power to a drying fan when the static pressure inside the grain bin exceeds a predetermined value.

There has thus been outlined, rather broadly, some of the features of the grain bin dryer pressure control system in order that the detailed description thereof may be better understood, and in order that the present contribution to the art may be better appreciated. There are additional features of the grain bin dryer pressure control system that will be described hereinafter and that will form the subject matter of the claims appended hereto. In this respect, before explaining at least one embodiment of the grain bin dryer pressure control system in detail, it is to be understood that the grain bin dryer pressure control system is not limited in its application to the details of construction or to the arrangements of the components set forth in the following description or illustrated in the drawings. The grain bin dryer pressure control system is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Example embodiments will become more fully understood from the detailed description given herein below and the accompanying drawings, wherein like elements are represented by like reference characters, which are given by way of illustration only and thus are not limitative of the example embodiments herein.

FIG. 1 is a schematic side view of a prior art grain bin.

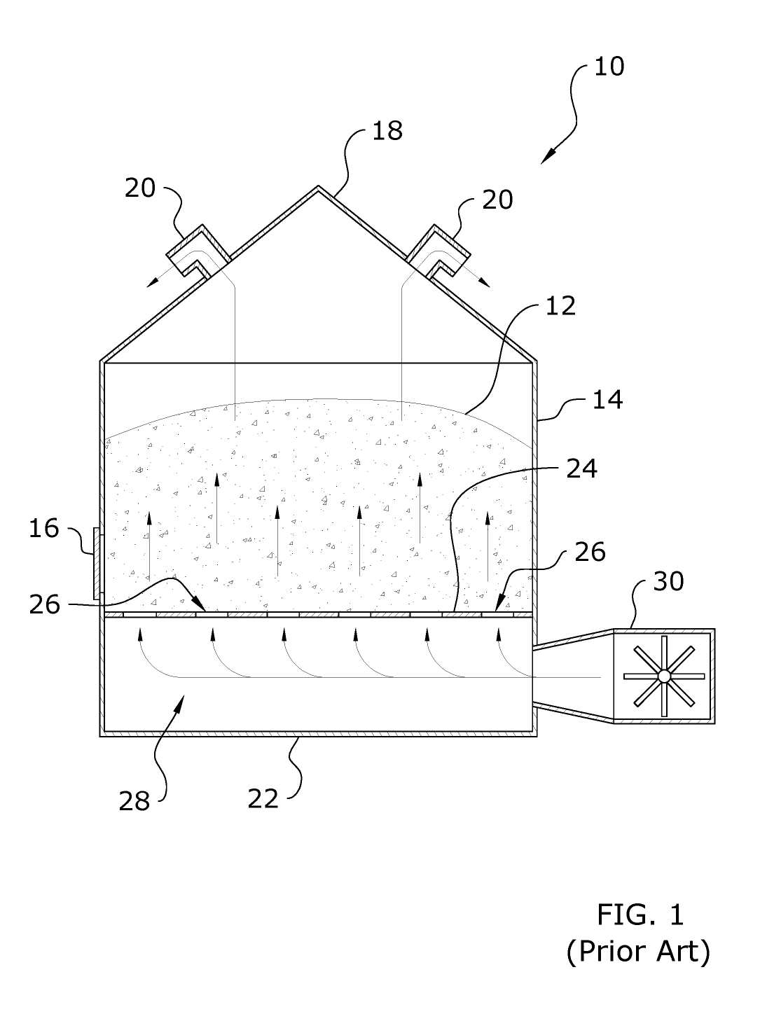

FIG. 2 is a schematic side view of a prior art grain bin experiencing an overpressure event.

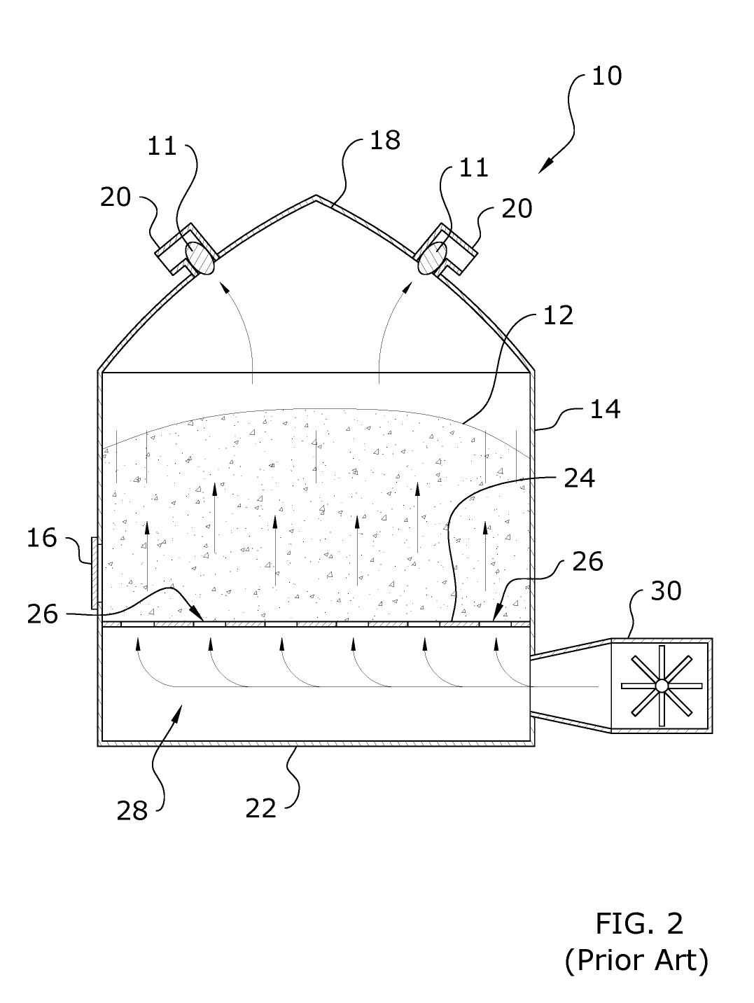

FIG. 3a is a block diagram of the grain bin dryer pressure control system in accordance with an example embodiment, including a first configuration of a switch to shut off power to dryer fans.

FIG. 3b is a block diagram of a second configuration a switch to shut off power to dryer fans of an example embodiment.

FIG. 4 is a schematic side view of the grain bin dryer pressure control system of FIG. 3a installed in a grain bin.

FIG. 5 is an upper perspective partial cutaway view of a grain bin with an example embodiment.

FIG. 6 illustrates alternative locations for the installation of the grain bin dryer pressure control system of FIG. 3a.

FIG. 7 is a block diagram of the grain bin dryer pressure control system in accordance with another example embodiment.

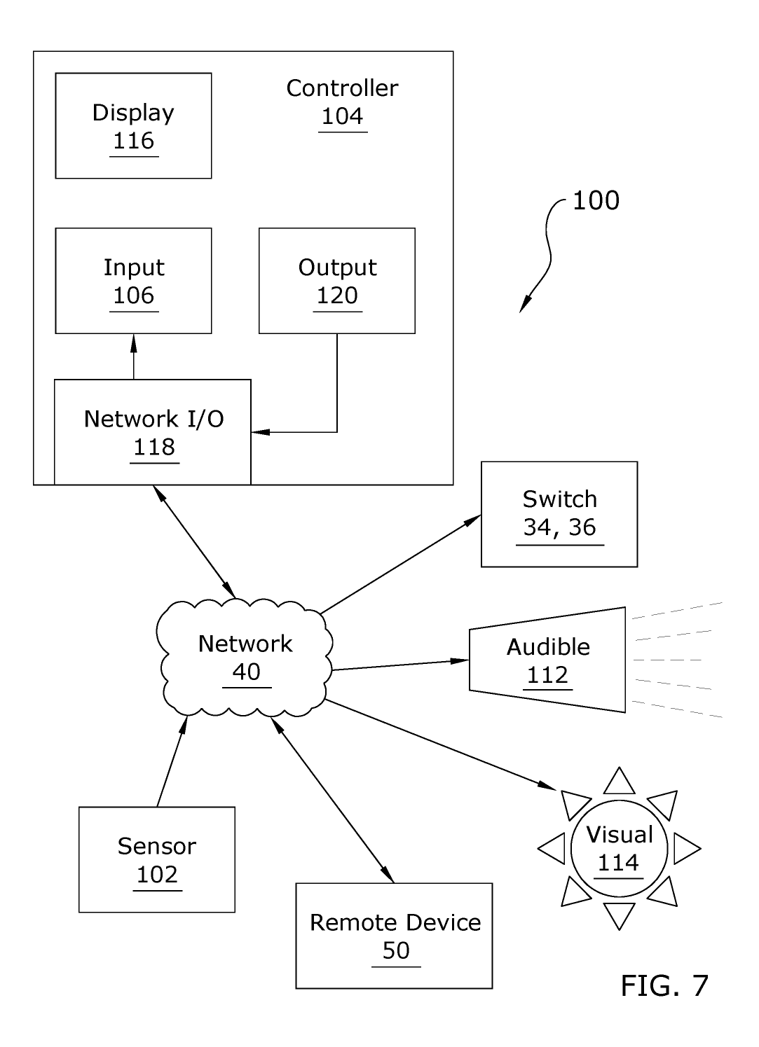

### DETAILED DESCRIPTION

An example grain bin dryer pressure control system generally comprises a static pressure sensor and a controller operable to turn off dryer fans if the pressure inside the bin exceeds a predetermined level.

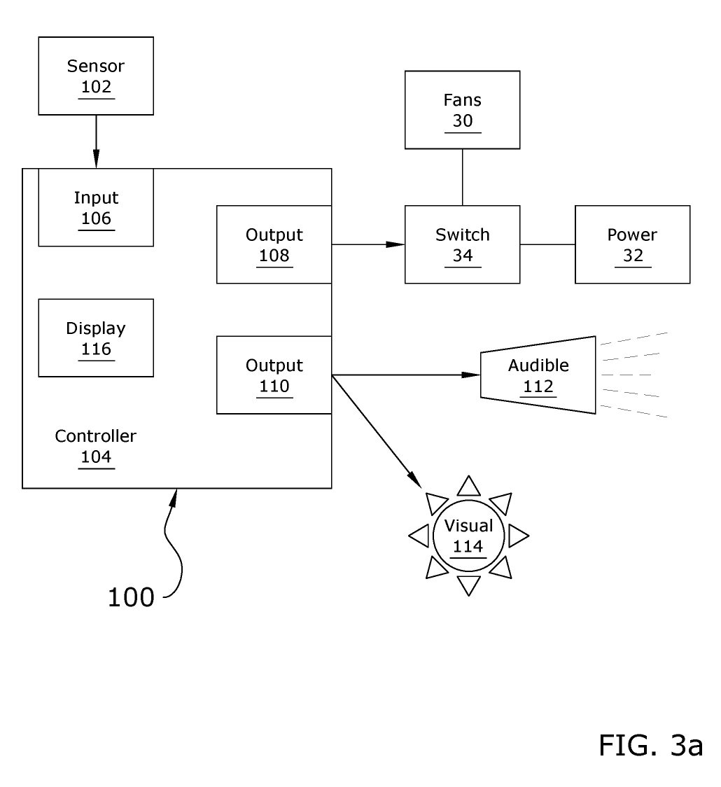

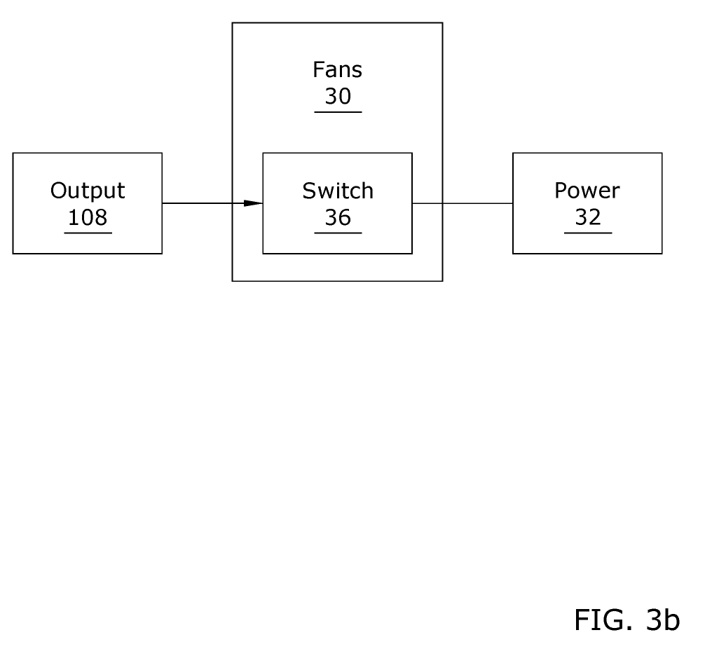

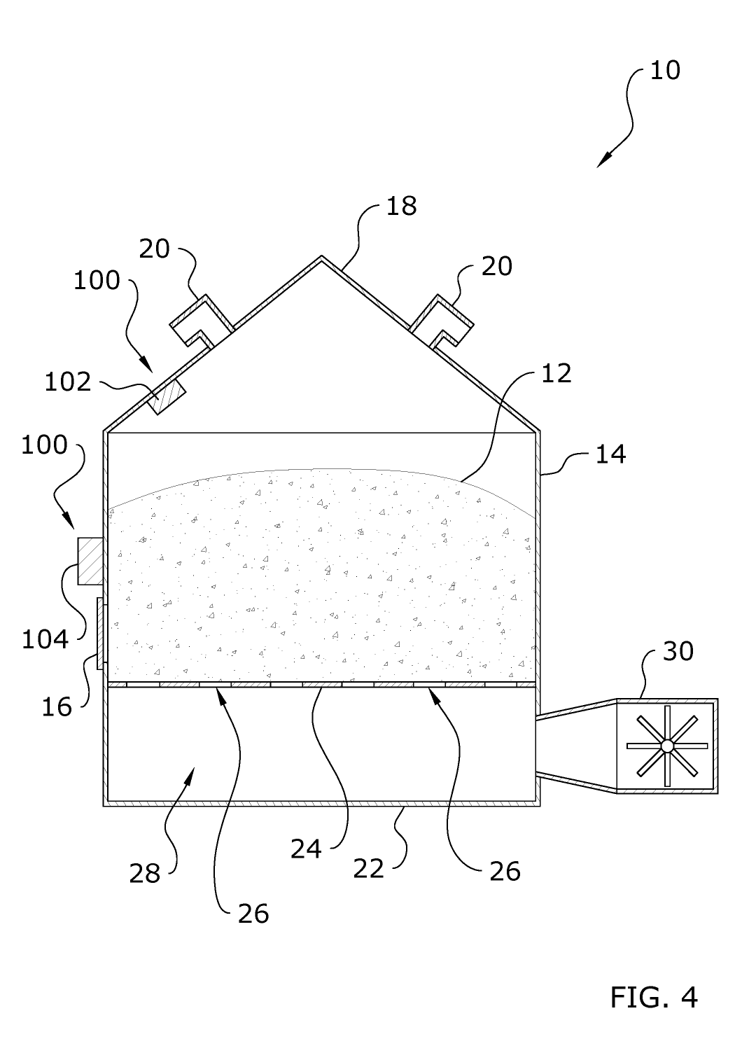

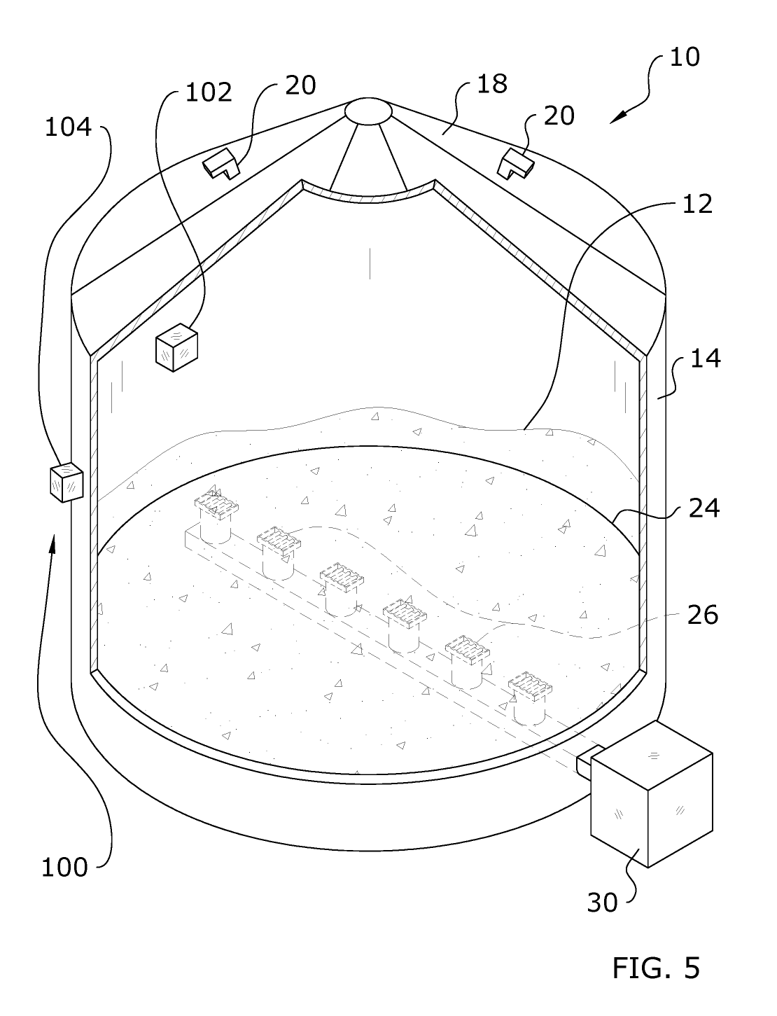

As illustrated in the block diagram of FIG. 3a, an example grain bin dryer pressure control system 100 generally comprises a static pressure sensor 102 and a controller 104. The controller 104 includes an input interface 106, configured to receive signals from the sensor 102, and an output interface 108 coupled to control power to one or more dryer fans 30. As illustrated in FIG. 4, the sensor 102 is preferably installed on the underside of the roof 18 of a grain bin 10, above the level of the grain 12. In this location (location ‘A’), the sensor may accurately measure the static pressure of the air within the bin 10. However, FIG. 5 illustrates other locations where the sensor 102 may also be installed, such as above the level of the grain on the inside of the sidewall 14 (location ‘B’), below the level of the grain on the inside of the sidewall 14 (location ‘C’), or on the inside of the sidewall 14 near the door 16 (location ‘D’). The controller 104 may be co-located with the sensor 102 or may be installed in convenient location, such as on the outside of the sidewall 14 near the door 16.

As illustrated in FIG. 3a, the output 108 may be operable to control a switch 34 electrically coupled between the dryer fans 30 and a power source 32 such that power to the fans 30 may be turned off by the controller 104. Alternatively, as illustrated in FIG. 3b, the output 108 may control a switch 36 within the fans 30, electrically coupled between the fans 30 and the power source 32, to turn the fans 30 off at the direction of the controller 104.

The controller 104 may also include an additional output 110 operatively coupled to an audible warning device 112, a visual warning device 114, or both. When shutting off the fans 30, the controller 104 may activate the audible warning device 112, such as a buzzer, bell, or siren, the visual warning device 114, such as a flashing light, or both, to alert workers of the problem.

The controller may also include its own a display 116 presenting the current static pressure inside the bin 10 to be viewed by a worker. The display 116 may also present past values of the static pressure, as a list or in graphical format for detecting any problematic trends.

To install the system 100, the sensor 102 is secured to the inside of the bin 10 at a location where it is able to accurately measure the static pressure of the air inside the bin 10, such as location ‘A,’ for example. If the controller 104 is not co-located with the sensor 102, the controller 104 is secured to a location where it is convenient for a user to make adjustments and monitor its operation. The sensor 102 is operatively coupled to the input 106 of the controller 104, such as with wire (FIG. 3a).

When the system 100 is installed, the controller 104 is adjusted to respond to a signal from the sensor 102 indicating that the pressure inside the bin 10 has reached a predetermined set point above which there is a risk of structural failure in the bin 10. For example, the predetermined set point could be, but is not limited to, about 0.75 inches of static pressure. However, the predetermined set point pressure may be greater than or less than 0.75 inches of static pressure based on various factors including the type of grain bin, typical expected weather conditions and the like. In use, the sensor 102 measures the static pressure inside the bin 10 and transmits the pressure signal to the controller 104. The controller 104 compares the value indicated by the received signal against the setpoint. As long as the indicated pressure is less than the setpoint, no action is taken. However, if the indicated pressure exceeds the setpoint, the controller 104, through the output 108, commands the switch 34 to shut off power to the fans 30, preventing further build-up of pressure and damage to the bin 10.

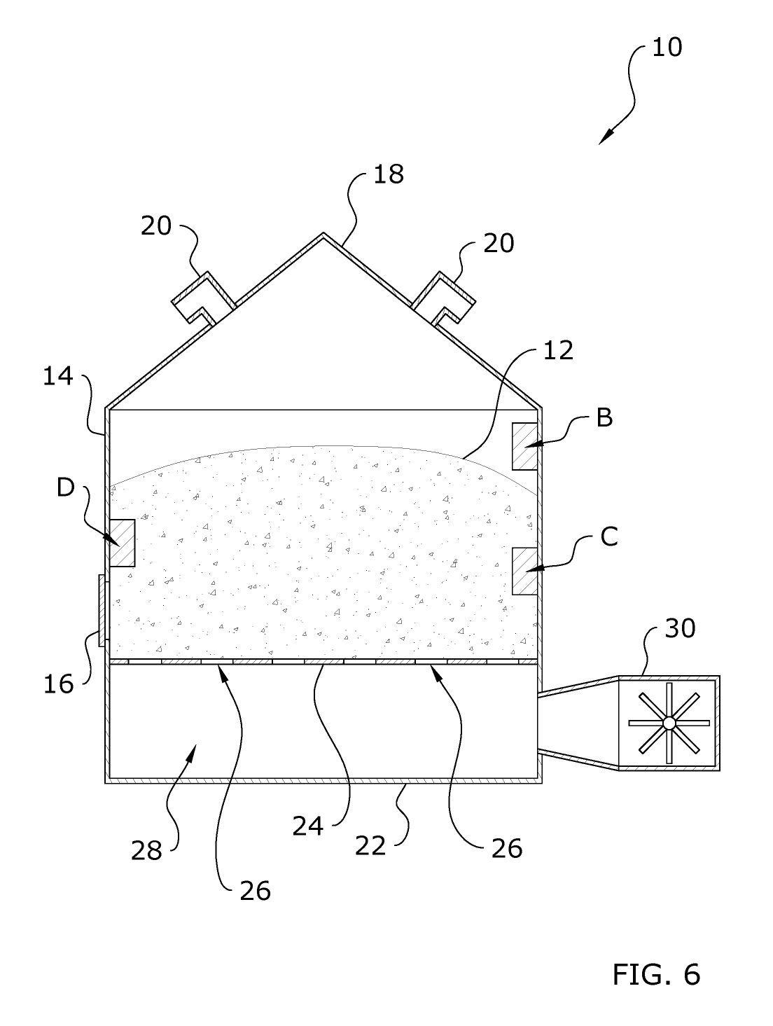

While FIG. 3a illustrates wired connections between the controller 104 and the sensor 102, switch 34, and warning devices 112, 114, the controller 104 may also include a network interface 118 to a network 40 (FIG. 6). The network 40 may be a wired or wireless local network and the interface 118 a wired or wireless interface. The network 40 may be a WiFi network or may include Bluetooth® communication. The network 40 may also be a cellular network and the interface 116 a cellular interface. The controller 104 may communicate with any or all of the sensor 102, switch 34, and alarms 112, 114 through the network 40. Thus, the sensor 102 may transmit the pressure signal to the controller 104 through the network interface 118 and the input 106. The controller 104 may direct that the switch 34, 36 shut off power to the fans 30 through the output 120 and the network interface 118. The controller 104 may also activate the warning devices 112, 114 through the output 120 and the network interface 118.

When the controller 104 shuts off the fans 30, it may also transmit a signal from the output 120 through the network interface 118 and the network 40 to a remote device 50. The remote device 50 may be any type of portable or fixed electronic device, such as a conventional cell phone, a smart phone, a tablet computer, a desktop computer, or a device dedicated to receiving signals from the controller 104. When the remote device 50 is a portable device, the worker is able to receive the signal from the controller 104 anywhere, whether on-site or not.

Although the network 40 is illustrated in FIG. 6 as being a single network, the system 100 be implemented with more than one network or type of network. By way of example only, the system may include Bluetooth communications between the sensor 102 and the controller 104, a local WiFi network between the controller 104 and the alarms 112, 114, and a cellular network between the controller 104 and the remote device 50.

The signal from the controller 104 to the remote device 50 may be a simple alert that the fans 30 were shut off or a more detailed message, such as by text or e-mail, that includes the time the fans 30 were shut off and the static pressure inside the bin 10. The controller 104 may also be configured to transmit a continuous or periodic signal containing a real-time indication of the static pressure within the bin 10. In this way, a worker may take note of any trends that indicate that the pressure is increasing because the exhaust vents 20 are becoming blocked. The worker may then take preventive steps, such as clearing the exhaust vents 20. If the remote device 50 has an appropriate display, the pressure values may be presented on the remote device 50 as a numerical list or in a graphical format for detection of trends in the pressure.

The controller 104 may also be configured to receive a signal from the remote device 50 through the network 40 and network interface 118. The received signal may comprise a command initiated by a worker to shut off power to the fans 30. For example, based on signals received on the remote device 50 from the controller 102, the worker may have noticed a trend of increasing pressure inside the bin 10 and want to turn off the fans 30 before the setpoint value is reached. That provides the worker with time to investigate and resolve the problem without the pressure increasing any further.

Unless otherwise defined, all technical and scientific terms used herein have the same meaning as commonly understood by one of ordinary skill in the art to which this invention belongs. Although methods and materials similar to or equivalent to those described herein can be used in the practice or testing of the grain bin dryer pressure control system, suitable methods and materials are described above. All publications, patent applications, patents, and other references mentioned herein are incorporated by reference in their entirety to the extent allowed by applicable law and regulations. The grain bin dryer pressure control system may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

What is claimed is:

1. A grain bin dryer pressure control system, comprising:
a static pressure sensor mounted inside a grain bin; and
a controller, comprising:
an input adapted to receive a signal from the pressure sensor indicative of a static pressure inside the grain bin; and
a first output operable to shut off power to the drying fan when the static pressure inside the grain bin exceeds a predetermined value.

2. The grain bin dryer pressure control system of claim 1, wherein the predetermined value is about 0.75 inches of static pressure.

3. The grain bin dryer pressure control system of claim 1, wherein the pressure sensor is mounted above grain stored inside the grain bin.

4. The grain bin dryer pressure control system of claim 3, wherein the pressure sensor is mounted on the underside of a roof of the grain bin.

5. The grain bin dryer pressure control system of claim 3, wherein the pressure sensor is mounted on a sidewall of the grain bin.

6. The grain bin dryer pressure control system of claim 1, wherein the controller further comprises a second output operable to activate a warning device when static pressure inside the grain bin exceeds the predetermined value.

7. The grain bin dryer pressure control system of claim 6, wherein the warning device comprises an audible warning device.

8. The grain bin dryer pressure control system of claim 6, wherein the warning device comprises a visual warning device.

9. The grain bin dryer pressure control system of claim 1, wherein:
the controller further comprises a network interface; and
the controller is further operable to transmit a signal through the network interface to a remote device when static pressure inside the grain bin exceeds the predetermined value.

10. The grain bin dryer pressure control system of claim 9, wherein:
the network interface is coupled to a cellular network; and
the signal comprises a text message.

11. The grain bin dryer pressure control system of claim 1, wherein:
the controller further comprises a network interface; and
the controller is further operable to transmit a signal through the network interface to a remote device indicative of a value of the current static pressure inside the grain bin.

12. The grain bin dryer pressure control system of claim 11, wherein the remote device displays the value of the current static pressure and values of past static pressure.

13. A method for preventing the static pressure inside a grain bin from exceeding a predetermined value, comprising:
mounting a static pressure sensor inside the grain bin;
coupling the pressure sensor to a controller;
coupling the controller to a switch controlling power to a dryer fan;
establishing a set point in the controller equal to the predetermined level;
receiving a signal from the pressure sensor indicative of the static pressure inside the grain bin; and
shutting off power to the dryer fan when the static pressure inside the grain bin exceeds the predetermined value.

14. The method of claim 13, wherein the predetermined value is about 0.75 inches of static pressure.

15. The method of claim 13, wherein mounting the pressure sensor comprises mounting the pressure sensor above grain stored inside the grain bin.

16. The method of claim 15, wherein mounting the pressure sensor comprises mounting the pressure sensor on the underside of a roof of the grain bin.

17. The method of claim 13, further comprising activating at least one of an audible warning device and a visual warning device when static pressure inside the grain bin exceeds the predetermined value.

18. The method of claim 13, further comprising transmitting a signal to a remote device when the static pressure inside the grain bin exceeds the predetermined value.

19. The method of claim 13, further comprising transmitting a signal to a remote device indicative of a value of the current static pressure inside the grain bin.

20. A grain bin dryer pressure control system, comprising:
a static pressure sensor mounted inside a grain bin, wherein the grain bin includes a drying fan to dry grain within the grain bin; and
a controller in communication with the static pressure sensor to receive a signal from the pressure sensor indicative of a static pressure inside the grain bin, wherein the controller is configured to shut off electrical power to the drying fan when the static pressure inside the grain bin exceeds a predetermined value.
